(19) United States
(12) Patent Application Publication
(10) Pub. No.: US 2023/0291247 A1
(43) Pub. Date: Sep. 14, 2023

(54) ELECTRIC MOTOR

(71) Applicant: MILWAUKEE ELECTRIC TOOL CORPORATION, Brookfield, WI (US)

(72) Inventors: Keith BOULANGER, Twin Lakes, WI (US); Anthony E. BREITBACH, Muskego, WI (US); Keith M. KLOSTERMAN, Gurnee, IL (US); Jorge L. IBARRA, Broomfield, WI (US)

(21) Appl. No.: 18/181,925

(22) Filed: Mar. 10, 2023

Related U.S. Application Data
(60) Provisional application No. 63/319,075, filed on Mar. 11, 2022.

(51) Int. Cl. H02K 1/02; H02K 7/116; H02K 7/14; H01F 1/057

(52) U.S. Cl. CPC H02K 1/02; H01F 1/0577; H02K 7/116; H02K 7/14

(57) ABSTRACT

The disclosure provides, in one aspect, an electric motor comprising a stator and a rotor assembly including a rotor body and a pinion gear integrally formed as a single piece with the rotor body.

### CROSS-REFERENCE TO RELATED APPLICATIONS

This application claims priority to co-pending U.S. Provisional Pat. Application No. 63/319,075, filed Mar. 11, 2022, the entire content of which is incorporated herein by reference.

### FIELD OF THE DISCLOSURE

The present disclosure relates to electric motors, and more particularly to structures and methods of making electric motors utilizing at least a powder metallurgy manufacturing process and optionally combined with other manufacturing process or processes.

### BACKGROUND OF THE DISCLOSURE

Tools, such as power tools, can include an electric motor having a stator to generate a magnetic field and a rotor configured to rotate upon excitation of the stator. The rotor may be coupled to an output gear and a gearbox. The stator and the rotor each may include a plurality of parts which makes assembly of the stator, the rotor, and the motor difficult.

### SUMMARY OF THE DISCLOSURE

The disclosure provides, in one aspect, an electric motor comprising a stator and a rotor assembly including a rotor body and a pinion gear integrally formed as a single piece with the rotor body.

In another independent aspect, a drive assembly comprises an electric motor and a transmission. The electric motor includes a stator including a stator core and a plurality of windings supported upon the stator core, and a rotor assembly including a rotor body and a pinion gear coupled to the rotor body and configured to rotate with the rotor body. The transmission includes a transmission housing integrally formed as a single piece with the stator core, and a driven gear supported within the transmission housing and drivably coupled to the pinion gear to receive torque therefrom.

In another independent aspect, a stator comprises a stator core and a plurality of windings. The stator core includes an annular portion having an inner circumferential surface and a plurality of first attachment features on the inner circumferential surface, the annular portion being made of a first material, and a plurality of tooth portions each having a second attachment feature configured to mate with the corresponding first attachment features of the annular portion to unitize the tooth portions with the annular portion, the tooth portions being made of a second material different than the first material. The plurality of windings are wound around the respective tooth portions of the stator core.

In another independent aspect, a method of manufacturing a rotor assembly of an electric motor comprises providing a rotor body including a first axial end, an opposite second axial end, and a cavity defined between the first axial end and the second axial end. The method also includes providing an aggregate magnetic material in solid or liquid form, and processing the magnetic material, using one or more of a sintering, bonding, or injection molding process, to form a solid magnetic body within the cavity.

Other features and aspects of the invention will become apparent by consideration of the following detailed description and accompanying drawings.

### BRIEF DESCRIPTION OF THE DRAWINGS

FIG. 1 is a perspective view of a portion of an electric motor having a rotor body with an integral pinion gear.

FIG. 2 is a cross-sectional view of the rotor body of FIG. 1 taken along section line 2-2 in FIG. 1.

FIG. 3 is a perspective view of a stator core of an electric motor according to another embodiment.

FIG. 4 is a side view of the stator core of FIG. 3.

FIG. 5 is an end view of the stator core of FIG. 3.

FIG. 6 is a cross-sectional view of the stator core of FIG. 3 taken along section line 6-6 in FIG. 4.

FIG. 7 is a perspective view of a rotor assembly having a rotor body with a plurality of cavities.

FIG. 8 is an exemplary cross-sectional view illustrating a method for manufacturing magnets within the cavities of the rotor body of FIG. 7.

Before any embodiments of the disclosure are explained in detail, it is to be understood that the disclosure is not limited in its application to the details of construction and the arrangement of components set forth in the following description or illustrated in the following drawings. Also, it is to be understood that the phraseology and terminology used herein is for the purpose of description and should not be regarded as limiting.

### DETAILED DESCRIPTION

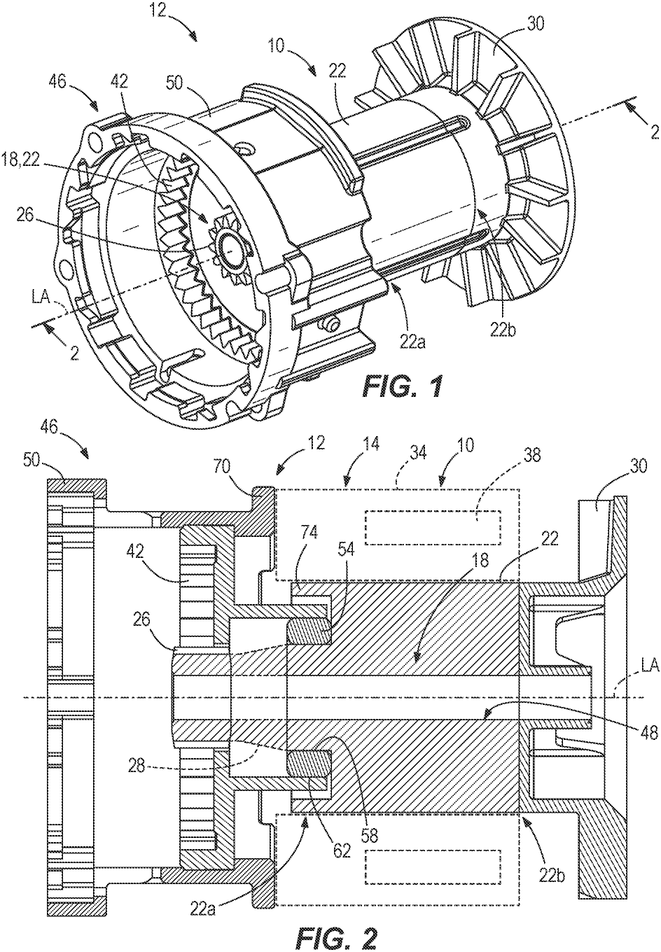

FIGS. 1 and 2 illustrate a brushless electric motor 10 including a stator 14 (FIG. 2) and a rotor assembly 18. The stator 14 and the rotor assembly 18 are each directed along a longitudinal axis LA of the motor 10. The rotor assembly 18 is rotatable about the longitudinal axis LA upon activation of the motor 10. The rotor assembly 18 includes a rotor body 22 (FIG. 2) and a pinion gear 26 which is integrally formed as a single piece with the rotor body 22. A transition portion 28 may couple the pinion gear 26 to the rotor body 22. The transition portion 28 may be annularly shaped about the longitudinal axis LA, as illustrated in FIG. 2, or the transition portion 28 may be annularly, cylindrically, or otherwise shaped with respect to the longitudinal axis LA. In the illustrated embodiment, the transition portion 28 extend axially in a direction parallel with the longitudinal axis LA. In other embodiments, the transition portion 28 may extend in differing directions relative to the longitudinal axis LA. In some embodiments, the transition portion 28 functions as a rotor shaft to connect the rotor body 22 to the pinion gear 26. In embodiments including the transition portion 28, the motor 10 need not include a rotor shaft (not shown).

In other embodiments, the pinion gear 26 may be otherwise integrally formed with the rotor body 22 during a common manufacturing process. For example, bot the rotor body 22 and the pinion gear 26 may be separately mechanically coupled with the rotor shaft, but formed simultaneously using a similar manufacturing process (e.g., a powder metallurgy process). In such embodiments where the pinion gear 26 and rotor body 22 are formed simultaneously (e.g., integrally formed through connection with a rotor shaft), the pinion gear 26 is coupled for co-rotation with the rotor body 22 by the rotor shaft.

An impeller 30 may be over-molded (as illustrated in FIG. 2) or otherwise coupled to the rotor body 22. The impeller 30 is configured to generate an airflow in response to rotation of the rotor body 22. Optionally, the rotor body 22 may include a mating element, a mating surface, a plurality of mating elements, or a plurality of mating surfaces for the impeller 30 to engage (i.e., clip or snap on to) the rotor body 22 during assembly. Such a mating element or mating surface may be provided adjacent the second axial end 22b of the rotor body 22. The mating element or mating surface may include any type of mechanical connection including but not limited to press-fit keys and keyways, pins, fasteners, welded connections, and the like. Optionally, the impeller 30 may be integrally formed as a single piece with the rotor body 22 during a powder metallurgy process of constructing the rotor body 22. Alternatively, the impeller 30 may be formed as separate pieces from the rotor body 22 but with a separate manufacturing process (e.g., another powder metallurgy process) from constructing the rotor body 22.

The stator 14 includes a stator core 34 and a plurality of windings 38 supported upon the stator core 34. The stator core 34 and stator windings 38 are illustrated diagrammatically in FIG. 2. The pinion gear 26 is configured to drive (i.e., directly drive, without an additional gear attached or otherwise secured to the rotor body 22) a driven gear (not shown) of a transmission 46. The driven gear is drivably coupled to the pinion gear 26, and is configured to receive torque therefrom. The driven gear is supported within a transmission housing 50 of the transmission 46. The driven gear may engage a ring gear 42 of the transmission 46. The driven gear functions as a rotating output of the transmission 46. The driven gear may be positioned within the transmission housing 50. The transmission 46 may be a single or multi-stage transmission. The electric motor 10 and the transmission 46, in combination, may be referred to as a drive assembly 12.

The rotor assembly 18 may be formed by a powder metallurgy process. During the powder metallurgy process, metal is melted and atomized into powder form leaving pure metal or metal alloys and a water or gas. A blend of powdered metal and/or metal alloys is prepared. The blend may optionally include lubricant, elementals, and/or other additives. The powder mixture is filled and pressed into a negative shape of a final part, called tooling. This mixture is compacted at pressures, for example, between 200-1500 MPa. Any binders remaining in the mixture are burnt off, and the resultant part is heated. The resultant part is heated and/or pressurized to create diffusion and/or solid-state bonding between particles of the blend. Amounts and durations of heating and/or pressurization vary dependent on alloy composition of the blend. Additionally or alternatively, the rotor assembly 18 may be formed in part by an additional or finalization processes of the powder metallurgy process which may include pressing and/or sintering of powder (e.g., in a soft magnetic composite [e.g., “SMC”] process). Such a powder metallurgy process may include, but is not limited to, casting, crushing milling, align-pressing, sintering, slicing, quenching, cold pressing, hot pressing, hot deformation, surface treatment, application of finish coating, magnetization, and/or machining of the rotor assembly 18. In other embodiments, the powder metallurgy process that forms the rotor assembly 18 (e.g., the rotor body 22 and the pinion gear 26) may include a compression and/or injection molding process.

Such a compression and/or injection process forming the rotor assembly 18 may utilize soft magnetic composite (e.g., “SMC”) material. In such embodiments, the rotor assembly 18 may additionally or alternatively be formed, in part, by utilizing a soft magnetic composite powder. In such powder metallurgy processes including soft magnetic composite powder, Iron (Fe) or otherwise magnetized particles having a magnetically insulating coating may be combined with other powders which form the rotor assembly 18. Heat treatment of such powder metallurgy processes including soft magnetic composite (e.g., “SMC”) powder may be conducted at relatively lower temperatures to maintain iron (Fe) or otherwise magnetic coating of the rotor assembly 18. Different metallic and/or alloy powders that form the blend of the rotor assembly 18 may be selected when utilizing soft magnetic composite powder.

The rotor assembly 18, which includes the rotor body 22 and the integrally formed pinion gear 26, may have many advantages over traditional rotor assemblies where a pinion gear 26 is press-fit to a separately formed motor output shaft. The rotor assembly 18 effectively reduces the part count, complexity, and length (e.g., duration) of assembly of the motor 10. As discussed above, the rotor assembly 18 may include a rotor body 22 having a shaft, or alternatively, the rotor body 22 may exclude a dedicated shaft, thus classifying the rotor body 22 as a “shaftless rotor”. Depending on the desired connection to the driven gear (not shown), the pinion gear 26 may be correspondingly configured. For example, the pinion gear 26 may be configured as a spur gear, bevel gear, or the like. The pinion gear 26 may be configured with a desired number of gear teeth to adjust a gear ratio between the pinion gear 26 and the driven gear (not shown). The rotor assembly 18 may include a hollow core 48 to provide material savings, which in turn, produce reduce cost of the rotor assembly 18. In the exemplary embodiment of FIG. 2, the hollow core 48 is positioned on a radially inner side of the rotor body 22 which faces the longitudinal axis LA. In the illustrated embodiment, the hollow core 48 generally corresponds with a volume which would typically receive a rotor shaft.

FIG. 2 further illustrates a bearing 54 positioned between the rotor body 22 and a stationary portion of the ring gear 42 and/or transmission housing 50. More specifically, the bearing 54 is radially positioned between a bearing mount surface 58 of the rotor body 22 and a hub 62 of the ring gear 42. The rotor body 22 includes a first axial end 22a and an opposite second axial end 22b. The first axial end 22a is positioned closer to the pinion gear 26 than the second axial end 22b. The second axial end 22b is positioned closer to the impeller 30 than the first axial end 22a. In the illustrated embodiment, the bearing mount surface 58 is positioned adjacent the first axial end 22a. In other embodiments (not shown), the bearing mount surface 58 (or an additional bearing mount surface 58 and bearing 54) may be positioned closer to the second axial end 22b than the first axial end 22a. In either embodiment, the bearing mount surface 58 may align and/or center the rotor body 22 with the longitudinal axis LA.

Other embodiments of the rotor body 22 are possible. For example, the pinion gear 26 may be positioned between the first axial end 22a and the second axial end 22b of the rotor body 22. In contrast, the illustrated pinion gear 26 is positioned axially beyond the first axial end 22a, and is connected to the first axial end 22a by the transition portion 28. This may effectively shrink the axial length of the motor 10 along the longitudinal axis LA. In other embodiments, the length of the transition portion 28 may be reduced and/or removed entirely such that the first axial end 22a is directly or more closely coupled to the pinion gear 26. Another exemplary rotor body 22 may include surface permanent magnets (SPM) mounted on a radially outermost surface of the rotor body 22. This contrasts with rotor bodies 22 that include interior permanent magnets (IPM) mounted on radially inner portions of the rotor body 22 within the bounds of the radially outermost surface of the rotor body 22.

FIG. 2 illustrates, in dashed lines, the stator 14. The stator core 34 may be integrally secured with or coupled to the transmission housing 50. In such embodiments including the stator 14 integrally secured with or coupled to the transmission housing 50, the stator core 34 may engage a standoff 70 of the transmission housing 50. The stator core 34 may be positioned adjacent (e.g., annularly within and closer to the longitudinal axis LA compared to) an annular boss 74 of the rotor body 22. In the illustrated embodiment, the standoff 70 protrudes radially outward from the transmission housing 50. The standoff 70 may function as a connecting portion which secures the transmission housing 50 to the stator 14 such that the transmission housing 50 and the stator core 34 may be integrally formed as a single piece.

In the illustrated embodiment, the rotor body 22 includes an annular boss 74 which axially protrudes from a position along the longitudinal axis LA corresponding with the first axial end 22a of the rotor body 22. The illustrated annular boss 74 is radially aligned with respect to the longitudinal axis LA when compared to the bearing 54. That is, a normal line extending radially outward from the axis LA bisects both the bearing 54 and the boss 74.

In other embodiments, the transmission housing 50 and the stator core 34 may be integrally formed. Forming this connection between the transmission housing 50 and the stator 14 may better unitize the components together for meshing between the pinion gear 26 and the driven gear (not shown) and/or other gears of the transmission 46. Further, such a connection may be adjusted to shorten the axial length of the motor 10 along the longitudinal axis LA.

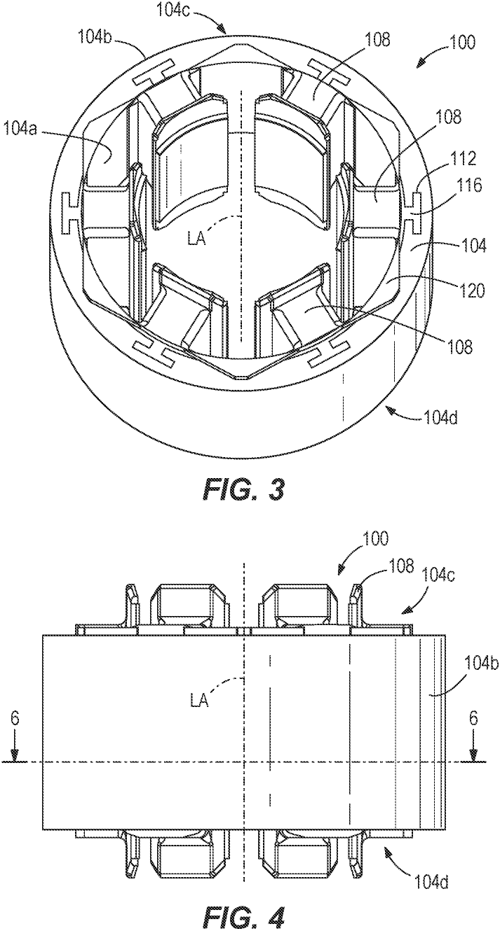

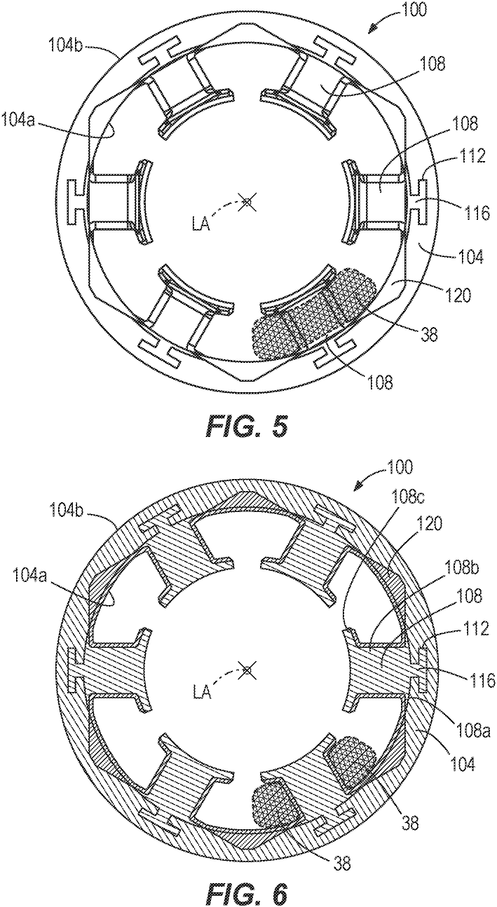

FIGS. 3-6 illustrate a stator core 100. As will be described in detail below, the stator core 100 is a hybrid or composite body formed from multiple (e.g., a plurality of) materials, having different material properties, which may enhance the efficiency of a motor including the stator core 100. In some embodiments, the stator 14 may include the stator core 100. As illustrated in FIG. 3, the stator core 100 includes an annular portion (i.e., an annular yoke) 104 having an inner circumferential surface 104a, an outer circumferential surface 104b opposite the inner circumferential surface 104a, a first axial end 104c, and a second axial end 104d opposite the first axial end 104c. The stator core 100 further comprises a plurality of tooth portions 108. The inner circumferential surface 104a includes a plurality of recesses (i.e., a plurality of “first attachment features”) 112. In the illustrated embodiment, the recesses 112 are “T-shaped.” The recesses 112 extend in a direction between the first axial end 104c and the second axial end 104d of the stator core 100. As shown in FIG. 5, for example, the “T-shape” generally describes the cross-sectional shape of the recess 112 perpendicular to the longitudinal axis LA. The recesses 112 may be “dovetail-shaped” or otherwise shaped. The tooth portions 108 each include a mating finger 116 (i.e., a “second attachment feature”). The mating finger 116 of each tooth portion 108 is configured to mate with the recess 112 of the annular portion 104 of the stator core 100. Accordingly, the tooth portions 108 and the annular portion 104 can be unitized in assembly of the stator core 100. In the illustrated embodiment, the mating finger 116 may be aligned with one of the recesses 112, and the tooth portions 108 can be translated along the longitudinal axis LA into position. In some embodiments, the mating finger 116 may engage the recess 112 in a press-fit arrangement where the mating finger 116 must be forced into engagement with the recess 112. In the illustrated embodiment of FIG. 4, the tooth portions 108 may project axially along the longitudinal axis LA from the first axial end 104c and the second axial end 104d of the annular portion 104. FIGS. 5 and 6 further illustrate the windings 38, which are wound around the tooth portions 108.

As best illustrated in FIG. 6, the illustrated tooth portions 108 include the mating finger 116, a skirt section 108a coupled to the mating finger 116 and extending radially outward from the mating finger 116, a protruding section 108b extending radially inward from the mating finger 116, and a tip section 108c extending circumferentially outward from the protruding section 108b opposite the skirt section 108a. The skirt section 108a may abut the inner circumferential surface 104a of the annular portion 104. The protruding section 108b may leave sufficient room within the stator core 100 to receive a rotor assembly such as the rotor assembly 18 of the motor 10.

An overmold 120 (FIGS. 3, 5, and 6) may be applied to the stator core 100. The overmold 120 may be applied at the first axial end 104c and the second axial end 104d of the annular portion 104. As best illustrated in FIG. 6, the overmold 120 may be applied to the inner circumferential surface 104a, the skirt section 108a, each lateral side of each protruding section 108b, and a portion of the tip section 108c that faces radially away from the longitudinal axis LA. In other words, the overmold 120 may be provided on each surface between adjacent tooth portions 108. The overmold 120 may be applied to different components of the stator core 100. For example, as illustrated in FIG. 3, the overmold 120 may be provided on at least one of the first axial end 104c and the second axial end 104d. Optionally, the overmold 120 may include soft magnetic composite material.

The tooth portions 108 and the annular portion 104 may be made of different materials. The annular portion 104 may be made of a first material such as a soft magnetic composite. Such a soft magnetic composite may be magnetized and demagnetized. In other words, the magnetic properties of the first material are not permanent. Such a soft magnetic composite may not be capable for handling high flux density, which may be required for the tooth portions 108. The tooth portions 108 may thus be made of a second material such as M19 (i.e., a silicon steel composite material or “electrical steel” which offers low core loss, which may include low carbon steel alloyed with the silicon steel) capable of handling high flux density. In some embodiments, the second material (e.g., M19) is configured to handle a higher flux density compared to the first material (e.g., soft magnetic composite). In the illustrated embodiment, the second material is different than the first material. The tooth portions 108 may exhibit higher losses due to switching frequency. This hybrid component and material stator core 100 may exploit strengths of each material and to more efficiently generate flux by the windings 38. Ultimately, this affords the designer an opportunity to obtain relevant material properties for the annular portion 104 and the tooth portions 108. Further, the tooth portions 108 may be pre-wound with the windings 38 by a bobbin. Bobbin winding may more efficiently apply the windings 38 (i.e., application may be faster, and more windings 38 may be applied around each tooth portion 108) to the tooth portions 108, thus achieving higher slot fill of the windings 38 in the stator core 100. Higher slot fill of the windings 38 increases the overall efficiency of the motor 10. Additionally or alternatively, soft magnetic composite (SMC) material may be molded (e.g., as an overmold such as the overmold 120) and/or pressed onto and/or around the tooth portions 108 to improve bonding (e.g., electromechanical bonding as well as mechanical coupling) between the tooth portions 108 and the annular portion 104 and/or between the windings 38 and the tooth portions 108.

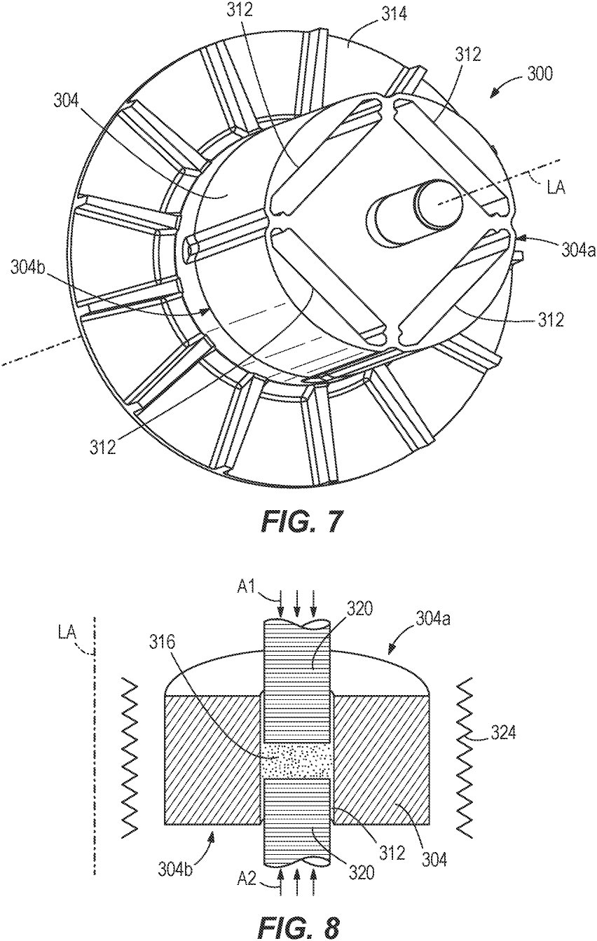

FIG. 7 illustrates a rotor assembly 300 for use in a motor, such as the motor 10 of FIGS. 1 and 2. The rotor assembly 300 includes a rotor body 304 having a first axial end 304a and an opposite second axial end 304b. The rotor body 304 includes multiple cavities 312 therein. Each of the cavities 312 extends between the first axial end 304a and the second axial end 304b of the rotor body 304. The cavities 312 are also circumferentially arranged about the longitudinal axis LA. An impeller 314 may be secured to the second axial end 304b of the rotor body 304 by any suitable mechanical connection means. For example, as described above, the impeller 314 may include any type of mating element or mating surface including but not limited to press-fit keys and keyways, pins, fasteners, welded connections, and the like, to secure the impeller 314 to the second axial end 304b of the rotor body 304.

FIG. 8 illustrates a method of manufacturing the rotor assembly 300. The rotor body 304 is provided, the rotor body 304 including the first axial end 304a, the opposite second axial end 304b, and at least one cavity 312 between the first axial end 304a and the second axial end 304b. An aggregate magnetic material, such as a magnetic powder 316, is inserted within the cavity 312. The magnetic powder 316 is sintered and magnetized to form a solid magnetic body, such as a magnetic bar, within the cavity 312. The powder 316 may otherwise be acted upon within the cavity 312 by another process (e.g., bonding) to form the magnetic bar. Additionally or alternatively, powder 316 may be in liquid or melt form and injection molded into the cavity 312 to form the magnetic bar. Or, the magnetic bar may be inserted into the cavity 312 after being injection molded. Similarly, the magnetic bar may be a pressed magnet including the magnetic powder 316 and a binder that are pressed together to enhance the filling ratio of magnetic powder 316 to binder. The magnetic powder 316 may be processed a second instance, using one or more of a second sintering, a second bonding, or a second injection molding process. The second sintering, second bonding, and second injection molding process may be the same as or different than the first instance of sintering, bonding, or injection molding magnetic powder (e.g., the magnetic powder 316). The resultant magnetic bar may form an interior permanent magnet. The magnetic bar may be shaped as a rectangular prism, a prism of another cross-sectional geometry, or any other viable three-dimensional shape.

Returning to the example in which magnetic powder 316 is positioned within the cavity 312, as illustrated in FIG. 8, the magnetic powder 316 may be suspended within the cavity 312 between dies 320. In the illustrated embodiment, one die 320 is applied to the first axial end 304a of the rotor body 304, and another die 320 is applied to the second axial end 304b of the rotor body 304. Force is applied to each of the dies 320 along arrows A1 and A2, respectively, to compress the magnetic powder 316 within the cavity 312. The dies 320 may apply pressure to the powder 316 to form the magnetic bar. Several cycles of pressing and refilling powder 316 within the cavity 312 may be required to achieve adequate compaction of the powder 316 to form the resultant magnetic bar. In other words, insertion of magnetic powder 316 within the cavity 312 and sintering the magnetic powder 316 may be repeated to incrementally form the magnetic bar within the cavity 312. In some embodiments, multiple filling and pressing operations could create segmented magnets within the same cavity 312. The segmented magnets may have, for example, opposing polarities along the longitudinal axis LA. In forming the segmented magnet, a second aggregate magnetic material with a second polarity may be positioned within the cavity 312 along with first magnetic material having a first polarity opposite the second polarity. Tooling (e.g., a tool or a plurality of tools tools), which control(s) operation of the dies 320, may also be configured to align the powder 316 within the cavity 312. Additionally or alternatively, a heating element 324 may be positioned adjacent the rotor body 304. The heating element 324 may apply heat to the rotor body 304, and thus, the magnetic powder 316, to form the magnetic bar. Such a sintering process of the rotor assembly 300 may provide secure placement of the resultant magnetic bar within the cavity 312 and may eliminate the need for costly separately produced magnets.

Although the invention has been described in detail with reference to certain preferred embodiments, variations and modifications exist within the scope and spirit of one or more independent aspects of the invention as described.

Various features of the invention are set forth in the following claims.

What is claimed is:

1. An electric motor comprising:
a stator; and
a rotor assembly including a rotor body and a pinion gear integrally formed as a single piece with the rotor body.

2. The electric motor of claim 1, wherein the rotor body and the pinion gear are formed by a powder metallurgy process.

3. The electric motor of claim 2, wherein the powder metallurgy process includes at least pressing and sintering.

4. The electric motor of claim 2, wherein the powder metallurgy process includes a soft magnetic composite.

5. The electric motor of claim 1, wherein the stator includes a stator core, and wherein the stator core is a composite body made from a plurality of materials.

6. The electric motor of claim 1, further comprising:
an impeller, and
a mating element disposed on the rotor body, the mating element configured to couple the impeller to the rotor body.

7. The electric motor of claim 1, wherein the rotor assembly includes an impeller integrally formed with the rotor body and the pinion gear, the impeller configured to generate an airflow in response to rotation of the rotor body.

8. A drive assembly comprising:
an electric motor including
a stator including a stator core and a plurality of windings supported upon the stator core, and
a rotor assembly including a rotor body and a pinion gear coupled to the rotor body and configured to rotate with the rotor body; and
a transmission including
a transmission housing integrally formed as a single piece with the stator core, and
a driven gear supported within the transmission housing and drivably coupled to the pinion gear to receive torque therefrom.

9. The drive assembly of claim 8, wherein the pinion gear is integrally formed as a single piece with the rotor body.

10. The drive assembly of claim 8, wherein the stator core is coupled to the transmission housing.

11. A stator comprising:
a stator core including
an annular portion having an inner circumferential surface and a plurality of first attachment features defined on the inner circumferential surface, the annular portion being made of a first material, and
a plurality of tooth portions each having a second attachment feature configured to mate with the corresponding first attachment features of the annular portion to unitize the tooth portions with the annular portion, the tooth portions being made of a second material different than the first material; and
a plurality of windings wound around the respective tooth portions of the stator core.

12. The stator of claim 11, wherein the first material of the annular portion is a soft magnetic composite.

13. The stator of claim 11, wherein the second material of the tooth portions is a silicon steel composite.

14. The stator of claim 11, wherein the first material is a soft magnet composite material which may be magnetized and demagnetized.

15. The stator of claim 11, wherein the second material is configured to handle a higher flux density compared to the first material.

16. The stator of claim 11, wherein the windings are wound around the tooth portions prior to the respective tooth portions being unitized with the annular portion.

17. The stator of claim 11, wherein the stator core further comprises an overmold provided on the inner circumferential surface and at least a portion of at least one of the plurality of tooth portions to improve bonding between the at least one of the tooth portions and the annular portion.

18. The stator of claim 11, wherein the first attachment features and second attachment features are dimensioned such that the tooth portions may be pressed into the annular portion.

19. The stator of claim 11, wherein tooth portions include a skirt section extending radially outwardly from the second attachment feature.

20. The stator of claim 11, wherein the first attachment features include a recess, and the second attachment features include a mating finger configured to mate with the recess.

21. A method of manufacturing a rotor assembly of an electric motor, the method comprising:
providing a rotor body including a first axial end, an opposite second axial end, and a cavity defined between the first axial end and the second axial end;
providing an aggregate magnetic material in solid or liquid form; and
processing the magnetic material, using one or more of a sintering, bonding, or injection molding process, to form a solid magnetic body within the cavity.

22. The method of claim 21, further comprising:
processing the magnetic material a second instance, using one or more of a second sintering, a second bonding, or a second injection molding process, wherein the second sintering, second bonding, and second injection molding process.

23. The method of claim 22, wherein the aggregate magnetic material is a first aggregate magnetic material, and wherein the method further comprises:
forming a segmented magnet by positioning a second aggregate magnetic material with a second polarity within the cavity, wherein the first aggregate magnetic material has a first polarity opposite the second polarity.

24. The method of claim 21, further comprising:
aligning the aggregate magnetic material within the cavity by a tool.

25. The method of claim 21, further comprising:
positioning at least one tool used for the sintering, bonding, or injection molding process adjacent the cavity.
